(19) United States
(12) Patent Application Publication
(10) Pub. No.: US 2019/0151803 A1
(43) Pub. Date: May 23, 2019

(54) EASILY-ASSEMBLABLE DIFFUSIOPHORETIC WATER FILTRATION DEVICE

(71) Applicant: Split Rock Filter Systems LLC, New Paltz, NY (US)

(72) Inventor: William Christian Gehris, New Paltz, NY (US)

(21) Appl. No.: 16/182,540

(22) Filed: Nov. 6, 2018

Related U.S. Application Data
(63) Continuation-in-part of application No. 16/122,699, filed on Sep. 5, 2018.
Application No. 16/122,699 is a continuation-in-part of application No. 15/861,273, filed on Jan. 3, 2018, now Pat. No. 10,155,182.
Application No. 15/861,273 is a continuation-in-part of application No. 15/861,273, filed on Jan. 3, 2018, now Pat. No. 10,155,182.
(60) Provisional application No. 62/587,510, filed on Nov. 17, 2017.
(60) Provisional application No. 62/587,510, filed on Nov. 17, 2017.
(60) Provisional application No. 62/587,510, filed on Nov. 17, 2017.

(51) Int. Cl. B01D 63/08; B01D 65/02

(52) U.S. Cl. CPC B01D 63/08; B01D 65/02; B01D 2315/10; B01D 2313/125; B01D 2313/24; B01D 2313/105

(57) ABSTRACT

An easily assemblable water filtration device includes an inlet manifold for receiving a colloidal suspension including colloidal particles in water; and a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane. An outlet splitter connects to or is at the outlet, the outlet splitter having a first splitter outlet and a second splitter outlet, the first splitter outlet for receiving water having a higher concentration of some of the colloidal particles than a second splitter outlet. The outlet splitter, the membrane and at least parts of the inlet can be removable.

This application claims the benefit of U.S. Provisional Patent Application 62/587,510, filed Nov. 17, 2017, the entirety of which is hereby incorporated by reference herein, and is also a continuation-in-part of U.S. patent application Ser. No. 15/861,273, filed Jan. 3, 2018, and U.S. patent application Ser. No. 16/122,699, filed Sep. 5, 2018, the entirety of both of which are hereby incorporated by reference herein.

This application relates generally to water filtration and more particularly to a diffusiophoretic water filtration device and method. BACKGROUND

WO 2018/048735 discloses a device operative in separating particles in a flowing suspension of the particles in a liquid which device comprises: a first, pressurized cavity or plenum adapted to contain a gas, separated by a first gas permeable wall from a second cavity or plenum which contains a charged particle containing liquid which also contains an ion species formed by the dissolution of the gas within the liquid, which is in turn separated by a second permeable wall from the ambient atmosphere or an optional, third, relatively reduced pressure cavity or plenum which may contain a gas or a vacuum; wherein: the permeable walls operate to permit for the transfer of a gas from the first cavity through the second cavity and through the second permeable wall to the atmosphere or a third cavity and, the pressure present in atmosphere or the third cavity is lesser than that of the first cavity, thus forming an ion concentration differential within the liquid and between the permeable walls.

The related article “Membraneless water filtration using CO2” by Shin et al. (Nature Communications 8:15181), 2 May 2017, describes a continuous flow particle filtration device in which a colloidal suspension flows through a straight channel in a gas permeable material made of polydimethylsiloxane (PDMS). A CO2 (carbon dioxide) gas channel passes parallel to the wall and dissolves into the flow stream. An air channel on the other side of the wall prevents saturation of CO2 in the suspension and the resulting gradient of CO2 causes particles to concentrate on sides of the channel, with negatively charged particles moving toward the air channel and positively charged particles toward the CO2 channel. The water away from the sides of the channel can be collected as filtered water.

The article “Diffusiophoresis at the macroscale” by Mauger et al. (arXiv: 1512.05005v4), 6 Jul. 2016, discloses that solute concentration gradients caused by salts such as LiCl impact colloidal transport at lengthscales ranging roughly from the centimeter down to the smallest scales resolved by the article. Colloids of a diameter of 200 nm were examined.

The article “Origins of concentration gradients for diffusiophoresis” by Velegol et al, (10.1039/c6sm00052e), 13 May 2016, describes diffusiophoresis possibly occurring in georeservoir extractions, physiological systems, drying operations, laboratory and industrial separations, crystallization operations, membrane processes, and many other situations, often without being recognized.

PCT Publication WO 2015/077674 discloses a process that places a microparticle including a salt in proximity to a membrane such that the microparticle creates a gradient generated spontaneous electric field or a gradient generated spontaneous chemiphoretic field in the solvent proximal to the membrane. This gradient actively draws charged particles, via diffusiophoresis, away from the membrane thereby removing charged particulate matter away from the membrane or preventing its deposition.

### SUMMARY OF THE INVENTION

The present invention provides a water filtration device comprising:
an inlet manifold for receiving a colloidal suspension including colloidal particles in water;
a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane; and
a removable outlet splitter for connecting to the outlet, the outlet splitter having a first splitter outlet and a second splitter outlet, the first splitter outlet for receiving water having a higher concentration of some of the colloidal particles than the second splitter outlet.

The present invention advantageously permits the use of removable outlet that can be easily cleaned or provided with different-sized outlets, or outlets having for example three splitter outlets. It also increases ease of assembly and the portability of a diffusiophoretic water filtration device.

Preferably the outlet splitter fits within an end of the outlet, so that the membrane can seal the outlet splitter to the diffusiophoretic water filter, for example by stretching the membrane around the outlet splitter.

The outlet splitter can include a plastic 20 micrometer thick sheet and have for example 125 micrometer thick tapes on each side as spacers to set the splitter in the middle of a 250 micrometer thick channel of the diffusiophoretic water filter, for example. The tapes can align with a diffusiophoretic water filter channel structure in a widthwise direction.

The first splitter outlet size may be altered as a function of the particles in the water exiting through the at least one outlet, for example an efficiency of the filtration. For example, if the amount of certain colloidal particles in the water in the second outlet exceeds a certain threshold, the first splitter outlet size can be increased.

The present invention also provides a water filtration device comprising:
an inlet manifold for receiving a colloidal suspension including colloidal particles in water;
a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane; the channel being defined by at least one gas permeable and water impermeable membrane in contact with the pressurizable gas chamber, the membrane in direct sealing contact with the inlet manifold; and
an outlet splitter for connecting to the outlet, the outlet splitter having a first splitter outlet and a second splitter outlet, the first splitter outlet for receiving water having a higher concentration of some of the colloidal particles than a second splitter outlet;

the inlet manifold including an integral extension of the membrane.

Flow velocity through the channel can be controlled accurately via the input pressure, for example via a water pressure reducing valve or a water pressure regulator. The inlet manifold thus can provide the colloidal suspension at a defined and variable pressure to the inlet of the flow channel, and thus also can contain a water pressure regulator. The pressure for example can be set at a defined pressure, for example via height regulation or a pump. Inlet manifold as defined herein is thus any structure that spreads the colloidal suspension to a predefined width for receipt by the inlet of the flow chamber.

By having the membrane be integral with the removable inlet manifold, a better seal is obtained, and the stretchability of the membrane is advantageously used. Preferably, the inlet manifold includes a vertical tube with the integral extension of the membrane surrounding and sealing the vertical tube. The integral nature of the extension of the membrane thus provides the direct sealing contact, and spreads the colloidal suspension for receipt by the inlet of the low chamber.

The present invention also provides a water filtration device comprising:
an inlet manifold for receiving a colloidal suspension including colloidal particles in water;
a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane; the channel being defined by at least one gas permeable and water impermeable membrane in contact with the pressurizable gas chamber, the membrane being removable from the pressurizable gas chamber; and
an outlet splitter for connecting to the outlet, the outlet splitter having a first splitter outlet and a second splitter outlet, the first splitter outlet for receiving water having a higher concentration of some of the colloidal particles than a second splitter outlet.

The membrane advantageously is easily removable and placeable on the gas chamber, facilitating assembly and disassembly.

In a preferred embodiment the channel is a closed channel defined by the membrane, a channel structure and a cover, all pre-assembled, and then placed directly on the gas chamber, and clamped there for example by elastic bands or weights if the structure is horizontal. A honeycomb steel structure for example can weigh down the preassembled against flanges or edges of the gas chamber.

One preferred membrane is a PDMS silicone membrane available from Specialty Silicone Products, Inc. of Ballston Spa, N.Y. and a preferred thickness of the membrane may be from 10 micrometers to 250 micrometers, and most preferably from 20 micrometers to 100 micrometers, for example 30 micrometers thick.

The membrane preferably is at least 5 cm wide by 1 m long, although larger widths and lengths are preferred.

The membrane preferably has a Shore A of between 40 and 60, and a tensile elongation of at least 1000 psi. The elongation to failure is preferably at least 200%, and most preferably at least 400%, and the tear B is at least 150 ppi.

In one embodiment, the cover may be made in one piece together with a channel structure of longitudinally extending channels, each for example of a thickness of 250 micrometers, width of 2.5 cm and extending a meter in length. The cover and channel structure thus may be etched for example via soft lithography into a single piece of PDMS material. A PDMS barrier between the channels and at the sides in the width direction of 0.5 cm micrometers can be provided, so that for a width of 12.5 cm, 4 channels can be provided. The single piece cover and channel structure can be laid over the PDMS membrane, which due to the air pressure, presses against the cover from below and forms stable channels. This embodiment provides channels for excellent fluid velocity control, and is easily detachable and cleanable. The cover for example, can be removed and the channels and the PDMS sheet sprayed with high velocity water. The device can then be quickly reassembled. The distance between an outer surface of the cover facing air, and the top of the channel structure can be for example 10 to 50 micrometers.

In a second alternate embodiment, the channel structure is provided separately from the cover, and is sandwiched by the membrane and the cover. In this embodiment, the cover may be similar to the membrane described above, and the channel structure may be for example a rectangle made of PVC or other plastic material with longitudinally extending channels open on the top and bottom to define longitudinally extending holes. The channel structure thus may be for example 250 micrometers thick, and the holes 2 cm wide with 0.5 cm spacing and extending 1.2 meters in length. The membrane and the cover can also be made as one structure, and folded over the channel structure. At the front end, the channel structure can be connected so that the inlet is provided by placing the colloidal suspension supply over the holes, and the rear end can have for example a top connector that allows the channels to be open and align with the outlet splitter. The rear end top connector provides for a more stable structure.

The separate channel structure also can be removed from the membrane and the cover and cleaned easily.

In both the first and second embodiments, the membrane can be seated on the pressurizable gas chamber hand held there by clamps, which can include a weighted structure placed on the cover or elastic bands that go around the cover and the gas chamber. The membrane also can be taped to the gas chamber or otherwise secured in a removable fashion, to thus clamp the membrane to the gas chamber. The weighted structure for example can be a honeycomb steel structure sitting on the cover and permitting the gas to pass to the atmosphere through the cover, and also aid in reducing any bulging caused by the gas pressure.

In both the first and second embodiments, alternate channel structures can be provided, for example depending on the type of colloidal suspension being filtered. Thinner or narrower channels structures down to for example 20 micrometer thickness or less could be provided if the colloidal particles and other particles to be removed were sufficiently small. Also wider or thicker channels are possible, which can make fouling with non-colloidal particles less likely.

The structure of both the first and second embodiments allows for easy swapping of various channel structures, by providing in the first embodiment different one piece cover and channel structure, and in the second embodiment by providing a different channel structure.

The gas preferably can be carbon dioxide, preferably pressurized to at least 120 kPa and most preferably to at least 130 kPa, preferably between 130 kPa and 200 kPa. As the channel thickness increases higher pressures may be desirable to create stronger pressure gradients. Advantageously given the open plenum structure of the gas chamber, gases with less than 100% carbon dioxide can be used even if these gases may contain soot or other particles, for example gases with carbon dioxide at less than 50% such as combustion waste gases. The membrane can prevent undesired particles from entering the water, and the plenum can be easily cleaned.

The channel preferably flows horizontally so that while the colloidal particles are in suspension and will not move downwardly on their own due to gravity, it is supposed that as the colloidal particles congregate and move downwardly due to diffusiophoresis, they may be aided by gravity. The horizontal configuration also has advantages in simplified outlet construction, as water can be removed easily through the first splitter outlet with the aid of gravity. In addition, since non-colloidal larger particles can also be filtered, the gravity can aid in the movement of these particles. Thus, the filter of the present invention can be used as a sedimentation aid for non-colloidal particles as well.

The present invention also provides methods for assembling a water filtration device, such as sealing an inlet manifold with a height pressure regulator to a diffusiophoretic water filter, attaching a removable outlet to a diffusiophoretic water filter, removably attaching a membrane to a pressurizable gas chamber, and/or placing a weighted structure on the water filter. The present invention also provides a method of cleaning of the water filter by separating at least part of the inlet manifold from the opening of the water filter and spraying the membrane and channels with clean water. The present invention also provides a method of transporting a water filtration device by removing at least part of the inlet manifold from the diffusiophoretic water filter and transporting the inlet manifold and the diffusiophoretic water filter separately. The present invention also provides a method of transporting a water filtration device by removing a membrane of the diffusiophoretic water filter from a pressurizable gas chamber and transporting the inlet manifold and the diffusiophoretic water filter separately.

The present invention also advantageously can provide a testing device for testing water for use in designing a larger diffusiophoretic water filter. Since wider membranes and a single pressurizable gas plenum are easily constructed, the performance of the water filter on certain particles such as PFOAs can be first measured with the testing device and then larger scale commercial diffusiophoretic water filtration devices according to, for example, a municipalities need, constructed.

### BRIEF DESCRIPTION OF THE DRAWINGS

One schematic embodiment of the water filtration system of the present invention is shown by reference to:

FIG. 1, which shows a schematic view of the system;

FIG. 2, which shows an embodiment of the water filtration device of the present invention schematically;

FIG. 3 shows a schematic top view of the water filtration device of FIG. 2;

FIG. 4 shows a schematic cross sectional view a first embodiment of a flow chamber including a sheet and a cover and a channel structure created by tapes;

FIG. 5 shows a schematic cross sectional view of a second embodiment with a flow chamber including two sheets and a sandwiched channel structure;

FIG. 6 shows an inlet area of the flow chamber of FIG. 5 schematically;

FIG. 7 shows an outlet area of the flow chamber of FIG. 5 schematically;

FIG. 8 shows schematically a removable outlet splitter; and

FIG. 9 shows the outlet splitter of FIG. 8 in a schematic view.

### DETAILED DESCRIPTION OF AN EMBODIMENT

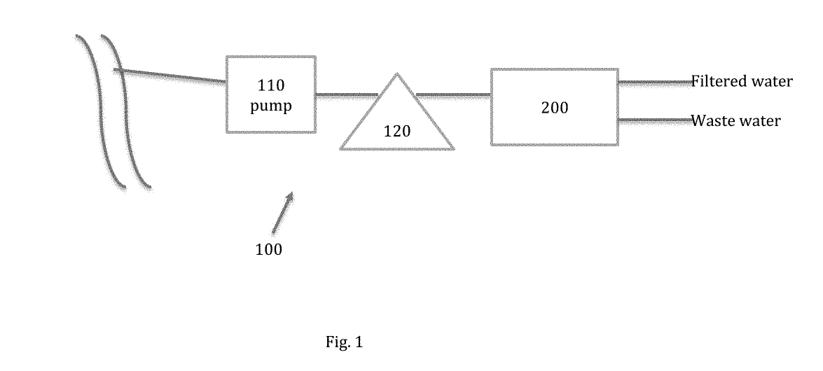

FIG. 1 shows a water filtration system 100 for cleaning river water, which may contain various particles such as colloidal plastic or metallic particles, PFOB, PFOAs, and/or other bioparticles such as bacteria and viruses. Many of these particles are charged negatively or positively. Any type of water with charged colloidal particles may be filtered using the present invention. “Colloidal particle” as defined herein is any particle that can form a colloid or colloidal suspension in water. Such colloidal particles typically range in sizes of a micrometer or less, but larger sizes are possible. The present invention is not limited to filtering colloidal particles, but can also be used to filter larger particles that are impacted by diffusiophoresis, for example even up to 100 nanometers in size or larger, from water. Preferably the particles to be filtered are less than 250 nanometers in size, even if not colloidal. These non-colloidal particles can have very low sedimentation rates, and thus the present invention can aid in “sedimentation” or forcing these larger particles downwardly.

Water filtration system 100 includes a pump 110 pumping water from a river. The pump 110 pumps the water through a sand filter 120 to remove larger particles and impurities. The water with suspended colloidal particles, i.e. a colloidal suspension, then passes to the water filtration device 200 of the present invention.

Water filtration device 200 is designed to remove positively charged colloid particles and other particles, the removal of which can significantly increase the water quality.

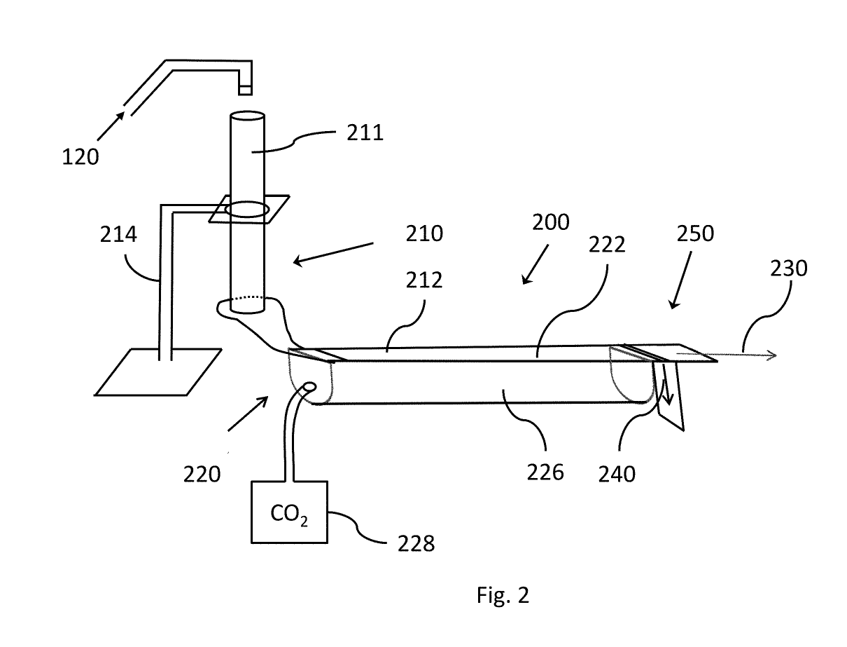

Water filtration device 200, shown in FIG. 2 schematically, has an inlet manifold 210 receiving pond or river water with colloidal particles, preferably having passed through a preliminary filter or sedimentation device, such as sand filter 120. However, water filtration device 200 could be upstream of sand filter 120, thereby removing bacteria and other particles that can foul the sand filter 120. Separate water filtration devices 200 could also be both upstream and downstream of sand filter 120.

Inlet manifold 210 spreads the water with colloidal particles in the widthwise direction from a pipe connected to sand filter 120. Inlet manifold 210 includes a vertical height regulator 211 which in this example can be a clear polycarbonate tube 7.5 cm in interior diameter and 1 meter in height and held by a stand 214. Water can be filled to a specific height in the pipe 211 and maintained at that height by the flow rate of water supplied from sand filter 120, which can equal the flow rate of the suspension through water filtration device 200. In this example the water with colloidal particles is spread in the inlet manifold from the 7.5 cm tube to a width of 12 cm and is maintained at a depth d of 51 cm, which height thus regulates the pressure of the suspension that flows into a flow chamber 212. Larger heights can provide larger pressures, and thus faster velocities through the flow chamber 212. The height or a pump can also be used to set the input pressure to a setpoint, for example 50 mbar, which equates to 51 cm of water height.

A pressurized gas chamber 220 receives a pressurized gas, such as carbon dioxide, from for example pressurized canisters or an industrial source 228. Gas chamber 220 has a gas tight wall 226, over which membrane 222 can be stretched taut and fastened to in a gas tight manner, for example with fasteners. Advantageously, due to the stretachable nature of membrane 222, which is for example made of PDMS, the membrane 222/wall 226 interaction can be sealant-free, especially on the sides. In one embodiment, gas chamber 220 can be made of galvanized steel, for example cut from 12.5 cm wide half-round galvanized steel gutter and sealed at both ends with galvanized steel caps. A hole for the pressurized gas can be cut in one of the end caps.

The pressurized gas thus can exit in a uniform manner through the membrane 222. Membrane 222 thus defines the top of gas chamber 220 and the bottom of flow chamber 212.

The colloidal suspension flows from inlet manifold 210 to flow chamber 212 via an inlet manifold exit. Flow chamber 212 can have water-tight sidewalls 318, 319 extending from and sealed with respect to membrane 222, and these sidewalls 318, 319 may be for example made of PTFE tape taped onto the membrane 222. The PTFE tapes may for example be 250 micrometer thick (10 mil) skived PTFE tapes, 5 mm wide, with acrylic adhesive available from CS Hyde Co. of Lake Villa, Ill.

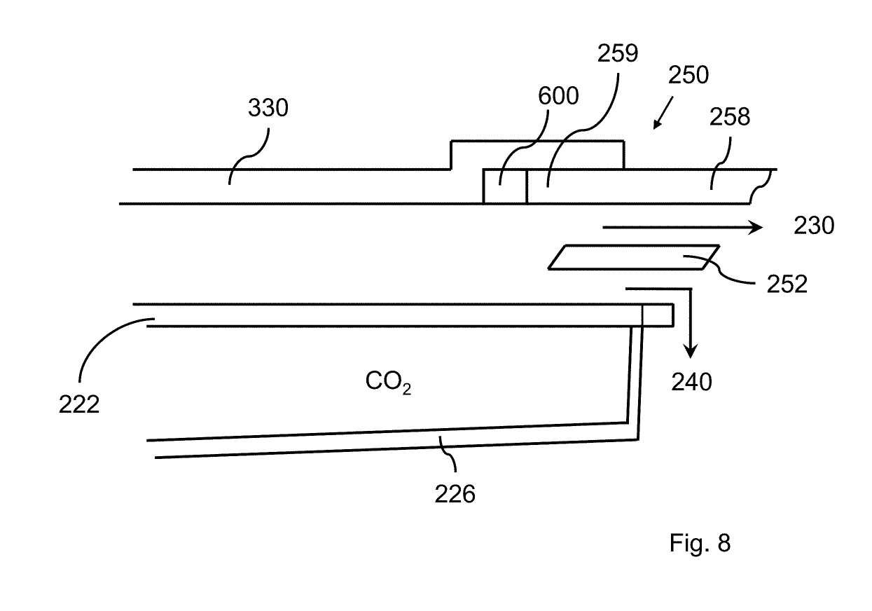

These tapes may also be used to provide a microfluidic or fluid structure therein as will be described. The colloidal suspension thus flows between inlet manifold 210 and an outlet splitter 250 with two outlets 230, 240 (FIG. 8) in a flow direction, and, with the closed flow chamber 212 of the present invention, the membrane or sheet 222 preferably is in a horizontal orientation to gain the benefit of any gravitational effects on the colloidal particles as they congregate. Other particles present in the water, for example up to 100 micrometers or larger in the largest dimension, can also be impacted positively by gravitational effects.

However, other orientations, even vertical, are possible especially for microfluidic chamber structures where the input pressure is the primary velocity driver.

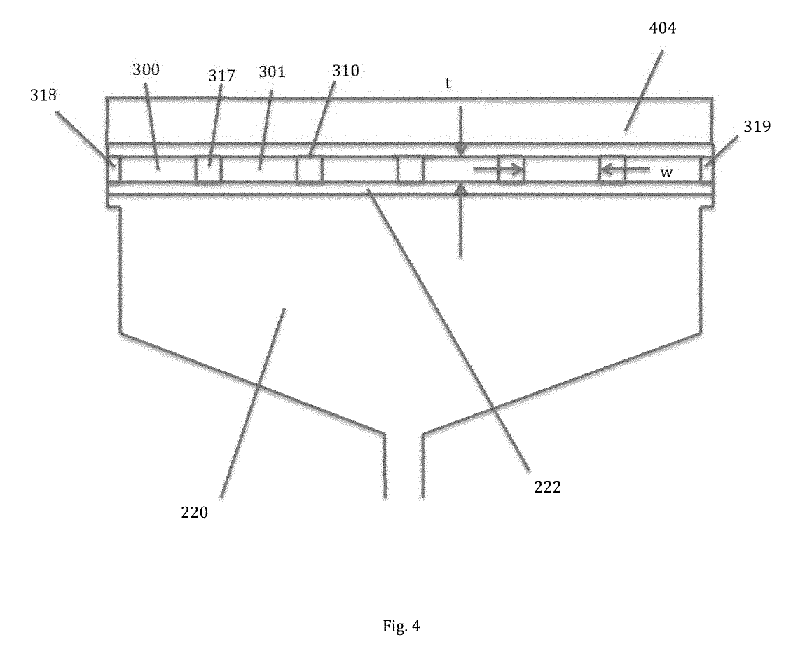

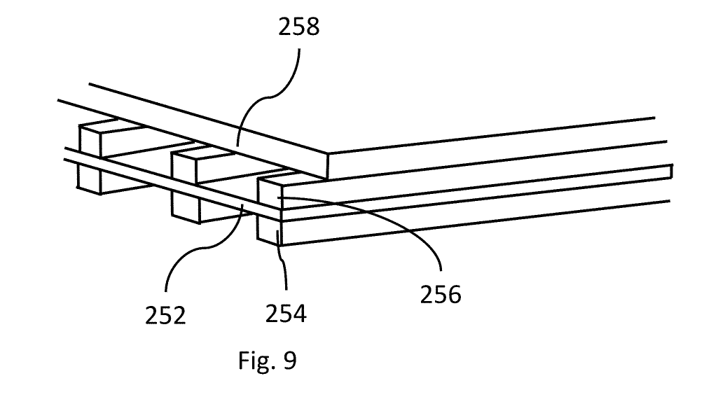

The carbon dioxide gas permeates the sheet or membrane 222 in a direction normal to the sheet or membrane 222, the normal direction being vertical in the embodiment shown in FIG. 4, so as to induce diffusiophoretic motion on positively charged colloidal particles opposite to the direction normal to the membrane, here toward membrane 222. Negatively charged colloidal particles can move away from membrane 222, and be filtered, split or suctioned from the top of the suspension. An outlet splitter 250 can split the stream to remove one or both of the sides of the stream in a heightwise direction, but need not remove both of the positively or negatively charged colloidal particles at the same time. The filtrate can be passed again through the device or a subsequent device to remove the other of the particles if the splitter solely has two outlets. Outlet splitter 250 will be described in more detail with regard to FIGS. 8 and 9 below.

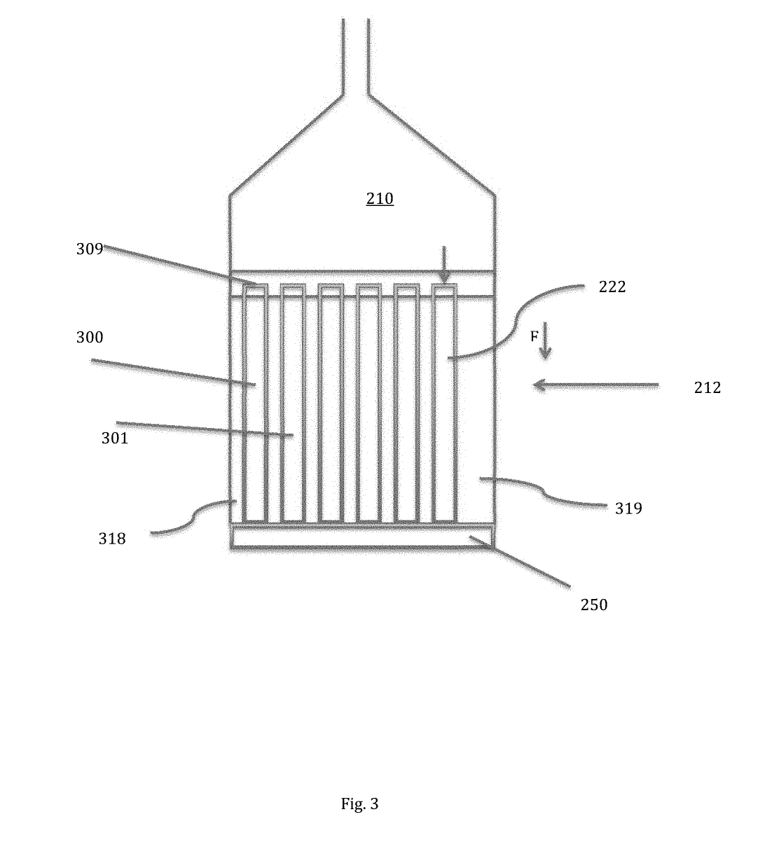

FIG. 3 shows a schematic top view of the water filtration device of FIG. 2, showing channels 300, 301, which extend a length l in the flow direction F, and a width w in a crosswise direction and have a thickness t (FIG. 2). The exit of inlet manifold 210 extends past front walls 309 (if present) of the channels, so the input pressure extant in inlet manifold 210 is transferred to the channels 300, 301. As the depth of the water is typically much larger than the thickness t of the channels 300, 301, the pressure in channels 300, 301 can generally be estimated as the pressure at the exit of the inlet manifold 210.

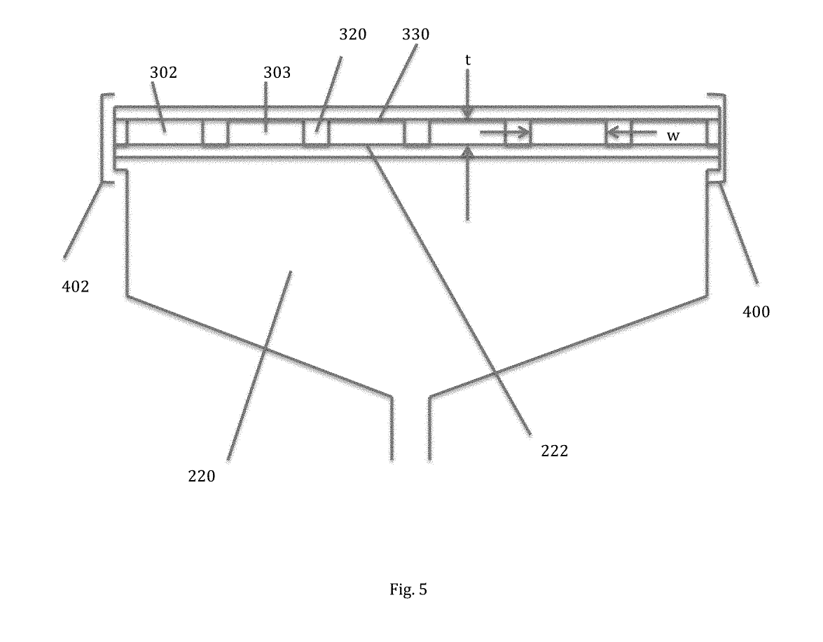

FIG. 4 shows a schematic cross sectional view a first embodiment of a flow chamber 212 including a sheet 222 and a cover and channel structure 310, having channels 300, 301 therein. Each channel 300, 301 can for example be of a thickness of 250 micrometers, width of 25 millimeters and extending approximately 1.2 meters in length, and be defined by PTFE tapes 318, 319 at the edges, and tapes 317 between the edges. The cover and channel structure 310 thus may be made easily by taping the tapes directly on membrane 222 with the adhesive side, while the top sides of the tape maybe contacted by a further membrane 310 that sits on the top sides of the tape and may be held there for example by an alternate or additional weight 404 which may be for example a honeycomb structure for example made of steel, and thus can define a clamp with edges or flanges of the gas chamber 220. Three PTFE tapes 317, 318, 319 between the channels in the width direction of 5 mm can be provided, so that for a width of 12.5 cm, 4 microchannels can be provided, if for example the two edge barriers also are PTFE tapes 5 mm wide. The PDMS sheet 222, which due to the air pressure from gas chamber 220, presses from below and forms stable microchannels, which can be aided by the air-permeable weight 404. The gas chamber 220 can be formed for example of metal, and may have longitudinally extending flanges 221 on both lateral sides, or be the gutter material mentioned above. However, clamps 400, 402 (FIG. 5), which generally are an alternative to the weight 404, could be for example a two part structure tightenable for example with bolts or screws or made of an elastic material that springs back to provide the clamping action

The FIG. 4 embodiment provides microchannels for excellent fluid velocity control, and is easily detachable and cleanable. The cover 310 for example, can be removed and the channels and the PDMS sheet and tapes, as well as the cover sprayed with high velocity water. The device can then be quickly reassembled. A distance 311 between an outer surface of the cover facing air, and the top membrane 310 can be for example 10 to 25 micrometers thick. Top membrane 310 also can be one piece with bottom membrane 222, and simple folded over around one of the tapes 318, 319 and then clamped. Such a folded integral single membrane structure can aid in possible leakage out one side, and also aid in sealing the inlet manifold.

FIG. 5 shows a schematic cross sectional view of a second embodiment with a flow chamber including sheet 222, a cover 330 formed as a second sheet and a sandwiched channel structure 320 forming channels 302, 303. In the second alternate embodiment, the channel structure 320 is provided separately from cover 330, and is sandwiched by the membrane or sheet 222 and the cover 330. In this embodiment, cover 330 may be similar to membrane or sheet 222 described above, and channel structure 320 may be for example a rectangle made of PVC or other plastic material, or PDMS or other polymer material, with longitudinally extending channels open on the top and bottom to define longitudinally extending holes. Channel structure 320 thus has a thickness t for example of 250 micrometers, and the holes formed by channels 302, 303 can be 25 millimeters wide and extending approximately 1.2 meters in length. At the front end, channel structure 320 can be connected so that the inlet manifold 210 is provided as in FIG. 2 by placing the colloidal suspension supply over the holes formed by channels 302, 303, and the rear end can have an outlet splitter to divide the outlet stream as will be described. Longitudinally extending clamps 400, 402 can contact the top of the cover 330 and the bottom of the flange 221 to clamp the membrane 222, channel structure 320 and cover 330 to the gas chamber 220.

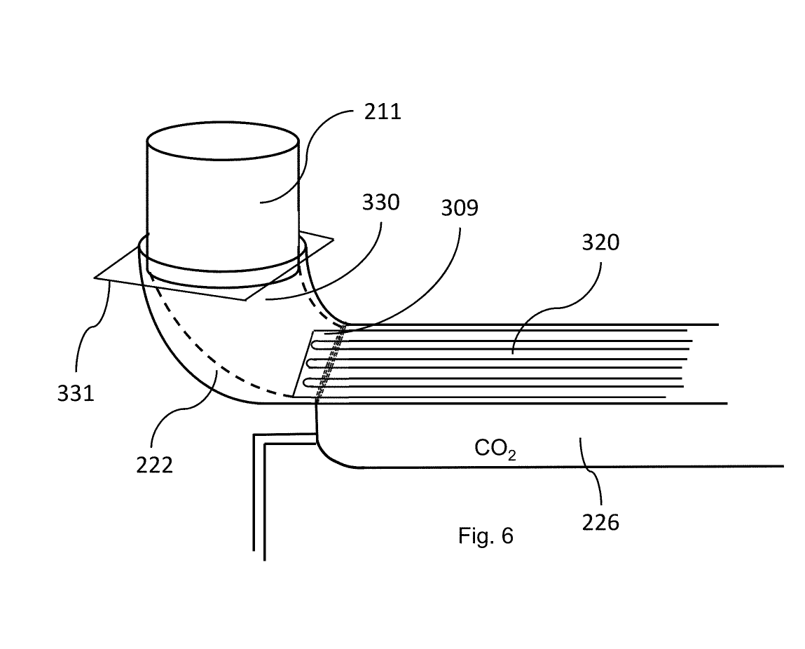

FIG. 6 shows an inlet area of the flow chamber of FIG. 5 schematically, with the front end of the channel structure 320 shown, and with top membrane 330 and bottom membrane 222 curving up over the end 309 to wrap around and seal pipe 211. The PDMS material is rather sticky and can provide a water-tight seal between the top membrane and the bottom membrane without extra adhesive, although a sealant could also be used to seal the membranes 222, 330 to each other as the membranes curve to the pipe 211. A clamp 331 can clamp the membranes 222, 330 to the pipe 211.

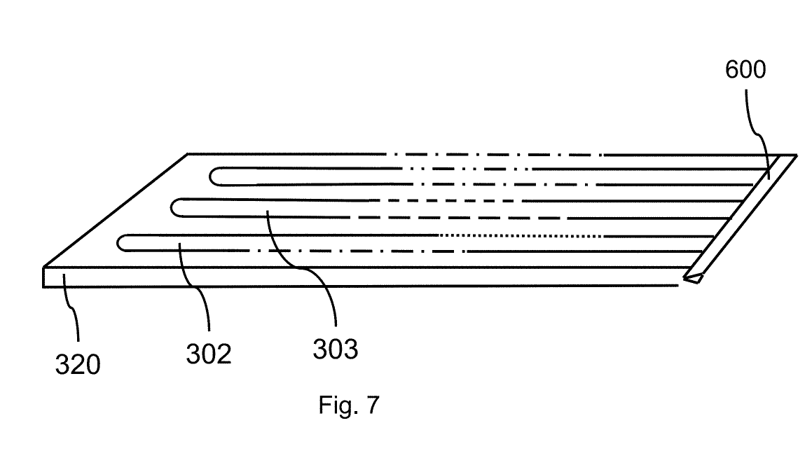

FIG. 7 shows an embodiment of the channel structure 320 made for example of 250 micrometer thick plastic with channels 302, 303 cut therein. The channels preferably are open at the outlet end to allow proper splitting. However, a cross bar 600, for example made of 1 mm thick plastic, can be attached to the outlet end to stabilize the channel structure, and still not alter the outlet splitting as will be described.

FIG. 8 shows an outlet area of the flow chamber 212 schematically.

As shown in FIGS. 8 and 9, outlet splitter 250 thus can have water having a higher concentration of positively charged colloidal and other particles at an outlet 240, defined as waste water although it can be re-used or refiltered, than at second outlet 230, which can be defined as having filtered water. The opposite definitions are possible however. For example a distilled water/iron oxide colloidal suspension with negatively charged iron oxide particles of an average particle size of 30 nanometers can be run through the device 200, and the water exiting at outlet 240 with a lower concentration of the iron oxide particles can be defined as filtered water, with the second outlet 230 away from membrane 222 being defined as waste water with a higher concentration of iron oxide particles.

Splitter 250 may be made for example from a 20 micrometer thick, 12.5 cm wide plastic sheet 252, such as available commercially as a shim, that fits between two sets of 125 micrometer thick tapes 254, 256 spaced widthwise to match tapes defining the channels 300, 301. The top set of tapes can be supported on a think steel or other splitter support 258 for example a galvanized steel 1 mm thick, 12.5 cm wide sheet.

Splitter 250 thus can be removable as a whole and replaceable with other sized outlets 240, 230. For example thinner tapes or three outlet structures could be used. Moreover, as shown in FIG. 8, top membrane 330 advantageously can seal the front end 259 of removable splitter 250 without the need for permanent sealants. The thickness of the splitter sheet 252 thus can be easily compensated for via the membrane elasticity.

In the example shown, splitter 250 first can be located at 125 micrometers above membrane 222 and at bottom of the outlet 240, so that about 125 micrometers of a 250 micrometer thick stream passes above the splitter sheet 252. Other sheet thicknesses thinner than 20 micrometers are possible, although the 20 micrometer thickness aids in stability especially if wider, for example 2.5 cm wide, channels are used.

The second embodiment also may be clamped in a similar manner to the first embodiment so that the cover 330, channel structure 320 and sheet 222 are clamped to form flow chamber 212. All of the parts can be easily disassembled and cleaned, for example with clean water sprayed at high pressure.

In the two embodiments shown, on one example, the thickness of the channels can be 250 micrometers, the width 25000 micrometers and the length 1200 mm. membrane 222 is approximately 12.5 cm wide×1.2 m long. An input pressure can be for example 50 mbar, or about 51 cm of input depth. Each of the four channels can produce a flow velocity of about 0.032729 m/s. A flow rate of 0.20455 mL/s (0.032729*250*25) or 12.2 ml/min, and has laminar flow with a Reynolds number of about 16. The dwell time of the colloidal suspension in the flow chamber 212 is approximately 36.7 seconds. The colloidal particle diffusiophoretic velocity will vary with colloidal particle zeta potential and concentration gradients over the thickness of the flow chamber, and the exact velocity for each colloid will vary. However, colloidal particle diffusiophoretic velocities of between 1 to 10 micrometer per second are typical, as stated in the “Origins of concentration gradients for diffusiophoresis” noted above at page 4687. Thus most positively charged colloidal particles, even if at the top of the input stream at the beginning of flow chamber 212, will move by the time the fluid has moved through the flow chamber 212 to outlet 240. A diffusiophoretic velocity of 5 micrometer per second would move colloidal particles by 183 micrometers, which is larger than half the thickness of the fluid, and thus congregate the negatively charged colloidal particles at the top of the stream at the outlet 230, and any positively charged colloids at stream of outlet 240.

The width of the channels being at least 1 cm is advantageous in that a large flow rate can be achieved for a channel. While some membrane bulging is disadvantageously present, with a weighted structure for example acting on the tapes and the water pressure forcing the water through, the bulging is less of a factor than might otherwise be expected for such thin membranes.

The flow rate overall for 4 microchannels thus is 48.8 mL/min or 2.928 liters per hour, and with a splitter height of 125 micrometers, a filtered water to waste water split ratio is approximately 50% to 50%, and a filtered water output is about 1.5 liters per hour.

The embodiment channel structure described above has a thickness of 250 micrometers, which for most colloidal suspensions is sufficient to reduce fouling. Smaller channel thicknesses of 20 micrometers or even smaller could be possible depending on the application, but thicknesses of 100 micrometers or more are preferred. The concentration gradients and diffusiophoretic velocities at higher thicknesses may be smaller, but the laminar flow and length of the flow chamber can compensate for these effects.

To maintain concentration gradients and laminar flow however, channel thicknesses of 1 mm or less are preferred, and sufficient to reduce most fouling.

The present device allows for a simply-constructed, relatively large flow rate water filtration device that can be generally free of fouling and easy to clean and maintain, all with a low energy consumption, and can be used for testing to scale to even larger filtration devices using wider membranes. Particles that become lodged in the channel structure can be removed during cleaning, and blockages are reduced. Thus even smaller channel structures, such as 20 micrometer thickness channel structures or smaller could be used, depending on the colloidal particles to be filtered. Since there is no gas channel structure other than a single plenum, construction and manufacturing is also simplified.

The present invention also provides that the partially filtered colloidal suspension, without the negatively charged colloidal particles can pass to a further downstream filter or be placed in the device again and the other output used to fully filter the water. Thus a single test device with only two outlets can be used, by passing the filtrate through the device again, for full testing of the diffusiophoretic device on a colloidal suspension with both positively and negatively charged particles.

What is claimed is:

1. A water filtration device comprising:
an inlet manifold for receiving a colloidal suspension including colloidal particles in water;
a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane; and
a removable outlet splitter for connecting to the outlet, the outlet splitter having a first splitter outlet and a second splitter outlet, the first splitter outlet for receiving water having a higher concentration of some of the colloidal particles than the second splitter outlet.

2. The device as recited in claim 1 wherein the outlet splitter fits within an end of the outlet, the membrane sealing the outlet splitter to the diffusiophoretic water filter.

3. The device as recited in claim 1 wherein the membrane stretches around the outlet splitter.

4. The device as recited in claim 1 wherein the outlet splitter includes a plastic sheet sandwiched between a set of two tapes on each side as spacers.

5. The water filtration device as recited in claim 1 wherein the at least one channel is a plurality of closed channels defined by the membrane, a channel structure and a cover.

6. The water filtration device as recited in claim 5 wherein the membrane is at least 5 cm wide by 1 m long.

7. The water filtration device as recited in claim 1 wherein the at least one channel is a plurality of closed channels defined by the membrane, longitudinally-extending tapes, and a cover.

8. The water filtration device as recited in claim 1 wherein the at least one channel includes at least four channels each at least 1 cm in width.

9. A water filtration device comprising:
an inlet manifold for receiving a colloidal suspension including colloidal particles in water;
a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane; the channel being defined by at least one gas permeable and water impermeable membrane in contact with the pressurizable gas chamber, the membrane in direct sealing contact with the inlet manifold; and
an outlet splitter for connecting to or at the outlet, the outlet splitter having a first splitter outlet and a second splitter outlet, the first splitter outlet for receiving water having a higher concentration of some of the colloidal particles than a second splitter outlet;
the inlet manifold including an integral extension of the membrane.

10. The water filtration device as recited in claim 9 wherein the inlet manifold includes a vertical height regulator sealingly attached to the integral extension.

11. A water filtration device comprising:
an inlet manifold for receiving a colloidal suspension including colloidal particles in water;
a diffusiophoretic water filter having at least one channel having an inlet and an outlet and for receiving the colloidal suspension at the inlet from the inlet manifold and flowing the colloidal suspension between the inlet and the outlet in a flow direction, the diffusiophoretic water filter having a pressurizable gas chamber for providing pressurized gas to the at least one channel via a gas permeable and water impermeable membrane; the channel being defined by at least one gas permeable and water impermeable membrane in contact with the pressurizable gas chamber, the membrane being removable from the pressurizable gas chamber; and
an outlet splitter for connecting to or at the outlet, the outlet splitter having a first splitter outlet and a second splitter outlet, the first splitter outlet for receiving water having a higher concentration of some of the colloidal particles than a second splitter outlet.

12. The water filtration device as recited in claim 11 wherein the at least one channel is a plurality of closed channels defined by the membrane, a channel structure and a cover.

13. The water filtration device as recited in claim 11 wherein the membrane preferably is at least 5 cm wide by 1 m long.

14. The water filtration device as recited in claim 11 wherein the at least one channel is a plurality of closed channels defined by the membrane, longitudinally-extending tapes, and a cover.

15. The water filtration device as recited in claim 11 wherein the at least one channel includes at least four channels each at least 1 cm in width.

16. A method for cleaning the water filtration device as recited in claim 1 comprising spraying the membrane with water.
